(19) United States
(12) Patent Application Publication
(10) Pub. No.: US 2004/0140296 A1
(43) Pub. Date: Jul. 22, 2004

(54) Close proximity pulsed laser catalyst deposition system and method

(76) Inventor: Steven A. Lis, Needham, MA (US)

Correspondence Address: IANDIORIO & TESKA, INTELLECTUAL PROPERTY LAW ATTORNEYS, 260 BEAR HILL ROAD, WALTHAM, MA, 02451-1018, US

(21) Appl. No.: 10/348,618

(22) Filed: Jan. 22, 2003

(51) Int. Cl. B23K 26/00

(52) U.S. Cl. 219/121.6; 219/121.61

(57) ABSTRACT

A close proximity pulsed laser catalyst deposition system comprising a first medium containing layer of a catalyst to be deposited, a second medium disposed across a gap from and facing the layer of catalyst to be deposited, the gap being at ambient atmospheric pressure, and a pulsed laser for applying an energy beam pulse above the ablative energy threshold of the catalyst to create a vaporized plume of the catalyst and direct the vaporized plume across the gap at ambient atmospheric pressure to deposit a porous, finely divided coating of increased surface area of the catalyst on the second medium.

### GOVERNMENT INTEREST

This invention was made with U.S. Government support under NSF-SBIR Contract No. 0128156. The Government may have certain rights in the subject invention.

### FIELD OF THE INVENTION

This invention relates generally to a pulsed laser deposition system and more particularly to a close proximity pulsed laser system and method for depositing a catalyst on a membrane.

### BACKGROUND OF THE INVENTION

Fuel cells utilize catalyzed electrochemical means to convert hydrogen and oxygen into water. Electrolyzers, driven by an electrical potential, reverse the process of the fuel cell by converting water to hydrogen and oxygen and similarly utilize catalysts for providing a controlled reaction.

A typical commercial fuel cell is a polymer electrolyte membrane (PEM) fuel cell. In the PEM fuel cell, the ideal catalyst materials are typically composed of precious metals, such and Pt, Ru, Ir, or alloys of these metals. The primary electrochemical element in a PEM fuel cell (or an electrolyzer) is the Membrane Electrode Assembly (MEA). The conductive polymer membrane of the MEA, typically Nafion or a similar competing material, is directly contacted by a catalyst layer. The catalyst layer is widely dispersed and electrically connected by a porous support, such as carbon black. The carbon black layer, often referred to as the gas diffusion layer (GDL), is further supported by a carbon paper, or carbon cloth backing which is electrically contacted and supported by the fuel cell separator plate, generally made of graphite. To enhance performance and life, the GDL is usually permeated with a binding agent such as Teflon and/or a solution of the conductive polymer and then dried at elevated temperatures.

The prior art techniques above fabricate the MEA of the PEM fuel cell as a sequence of layers, including the catalyst layer, which generally compromise performance, practical fabrication, and fundamental chemical engineering issues. The fabrication procedures used in these prior art methods are labor intensive because the methods employ small batch, low volume processes which increase the production costs.

Moreover, these prior art methods typically deposit a catalyst layer which is 50 μm thick. The 50 μm thickness of the catalyst layer of these methods is required by these prior art methods because of process uniformity requirements which require the deposition of the thick layer in order to guarantee sufficient catalyst coverage.

However, the optimal thickness of the catalyst layer is actually only the 5 to 10 μm of catalyst that are closest to the polymer membrane and are actually functional. See Taylor, E. J., E. B. Anderson, et al. (1992), “Preparation Of High Platinum-Utilization Gas Diffusion Electrodes For Proton-Exchange-Membrane Fuel Cells”, Journal of the Electrochemical Society, 139(5): L45-L46; and Ticianelli, E. A., C. R. Derouin, et al. (1988), “Localization Of Platinum In Low Catalyst Loading Electrodes To Attain High Power Densities In SPE Fuel Cells”, Journal Electroanal. Chem., 251: 275-295, both hereby incorporated herein by this reference.

As shown above, prior methods for depositing a catalyst on the membrane of a fuel cell require processing the catalyst as a sequence of layers. These methods require complicated fabrication methods which are labor intensive, and utilize a layer of catalyst material which is thicker than required, resulting in a high production costs.

A number of attempts have been made to address the problem associated with the excess layer of catalyst material. A few methods have been successful on the laboratory scale of reducing catalyst loading for both the cathode and the anode.

One such prior art method is sputtering, or vacuum evaporation, of catalyst layers. Using this prior art method, the sputtered catalyst layers are deposited on a membrane, e.g., a carbon anode or cathode, under moderate to high vacuum condition. These methods have shown promising results with catalyst loading as low as 0.1 mg/cm². See Ticianelli, E. A., C. R. Derouin, et al. (1988), “Localization Of Platinum In Low Catalyst Loading Electrodes To Attain High Power Densities In SPE Fuel Cells”, Journal Electroanal. Chem., 251: 275-295, hereby incorporated herein by this reference.

However, the high processing costs associated with sputtering are prohibitive for the mass-production of fuel cells because the materials associated with making fuel cell MEAs are very porous, hydroscopic, or both, making it very difficult to achieve high vacuum when the materials are placed in the chamber. The resulting out-gassing problems lead to long pumping times which increase processing cost.

Another prior art method of catalyst loading is catalyst ink-transfer. This method can provide exceptionally low catalyst loadings while maintaining high performance. See Wilson, M. S., J. A. Valerio, et al. (1995), “Low Platinum Loading Electrodes for Polymer Electrolyte Fuel Cells Fabricated Using Thermoplastic Ionomers”, Electrochimica Acta., 40(3): 355-363, hereby incorporated herein by this reference. In this method, carbon supported catalyst is formulated into an ink that is transferred to the polymer membrane surface, dried, and hot pressed. Several more complicated processing steps are required to restore membrane performance and assemble and test the structure as a fuel cell.

Although the results for this prior method are impressive, showing excellent cell performance with only 0.12 mg/cm² of Pt used on the cathode, a number of the process steps are difficult, complicated, time-consuming and difficult to scale up to production volumes.

Conventional pulsed laser deposition is a method used to deposit metallic thin films. However, this method has not been applied to the deposition of materials for use as catalysts. The basic concept of conventional pulsed laser deposition is that by using short time duration pulses (e.g., 10 nsec or less) a modest power laser can provide sufficient power densities to rapidly ablate virtually any thin layer of material from any surface. The ablated material is effectively vaporized as temperatures readily exceed 10,000° K and a plasma is typically formed. See Douglas B. Chrisey and Graham K. Hubler, Pulsed Laser Deposition of Thin Films, John Wiley & Sons, Inc., 1994, hereby incorporated herein by this reference. A significant drawback of the prior art pulsed laser methods is that the method must be performed under moderate to high vacuum conditions which increase the complexity and expense of the process.

An alternative prior art pulsed laser deposition process relates to the deposition of lithographic features. This process is notable because it is conducted in close proximity between the metal layer (which may be as much as 1 μm thick) from the transparent backing material to the electronic device laden substrate. See U.S. Pat. No. 4,752,455 entitled “Pulsed Laser Microfabrication”, incorporated by reference herein. Using this prior art technique, metallic features can be inserted into electronic circuits without the need for complex multi-step processes. However, the metallic layers produced by this method are not suitable for efficient catalytic action, since they produce low surface area, solid metallic features that do not make most efficient use of the precious metals required.

Conventional small to modest sized fuel cells incorporate a fuel cell catalyst and electrically conductive regions which are localized on the surface of the fuel cell polymer membrane. See U.S. Pat. Nos. 5,631,099, 5,759,712, 6,326,097, 4,673,624, and 6,194,095, incorporated by reference herein. These devices create a series of individual small cells that can then be interconnected in series (or parallel) by incorporating a contacting pattern. These prior art fuel cells permit generating a higher total voltage (6 to 10 volts) while only processing and handling a single piece of polymer film. Typically these prior art devices are used only for small fuel cells, such as for replacing small batteries for portable devices.

These prior art fuel cells typically utilize “masks” which prevent the materials, particularly catalysts, from being deposited in certain regions, while allowing the catalyst to be deposited in others. This design is equivalent to a stenciling approach which allows the creation of a detailed deposition pattern. However, a distinct drawback of this design is that the source of material is actually poorly directed. Moreover, these prior art devices waste material because a significant amount of the material to be deposited ends up on the mask or stencil. While this material can be recovered, it takes effort, time and money.

### BRIEF SUMMARY OF THE INVENTION

It is therefore an object of this invention to provide an improved close proximity pulsed laser catalyst deposition system and method.

It is a further object of this invention to provide such a system and method which deposits a thin layer of catalyst on a membrane at the optimal functional thickness of the catalyst layer under atmospheric or near atmospheric conditions.

It is a further object of this invention to provide such a system and method in which the catalyst layer deposited on the membrane is 0.04 mg/cm².

It is a further object of this invention to provide such a system and method which eliminates the need for vacuum conditions.

It is a further object of this invention to provide such a system and method which is a dry process.

It is a further object of this invention to provide such a system and method which is cost efficient.

It is a further object of this invention to provide such a system and method which eliminates the need for catalyst preparation and intermediate chemical processing.

It is a further object of this invention to provide such a system and method which is easily scalable to large systems.

It is a further object of this invention to provide such a system and method which requires only 1 to 1.5 J/cm² of laser energy to ablate a catalyst layer onto a membrane.

It is a further object of this invention to provide such a system and method which selectively deposits a thin layer of catalyst on a membrane at the optimal functional thickness of the catalyst layer under atmospheric or near atmospheric conditions.

The invention results from the realization that a truly effective close proximity pulsed laser catalyst deposition system and method can be achieved by utilizing a pulsed laser to apply an energy beam pulse above the ablative energy threshold of a catalyst material disposed on a first medium to create a vaporized plume of the catalyst material; the plume of catalyst is then directed across a small gap, typically a millimeter or less and at ambient atmospheric pressure, to a second medium; the plume of catalyst is efficiently deposited as porous, finely divided coating of increased surface area. This invention results from the further realization that optimal functional thickness can be achieved by multiple catalyst and carbon black deposition steps.

This invention features a close proximity pulsed laser catalyst deposition system including a first medium containing layer of a catalyst to be deposited, a second medium disposed across a gap from and facing the layer of catalyst to be deposited, the gap being at ambient atmospheric pressure, and a pulsed laser for applying an energy beam pulse above the ablative energy threshold of the catalyst to create a vaporized plume of the catalyst and direct the vaporized plume across the gap at ambient atmospheric pressure to deposit a porous, finely divided coating of increased surface area of the catalyst on the second medium.

In one embodiment, the ambient atmospheric pressure includes atmospheric and near atmospheric pressure. In one design, the gap is less than approximately one centimeter. In other designs, the gap is approximately one millimeter or less. The first medium may be transparent at the wavelength of the pulsed laser. Typically, the pulsed laser is on the opposite side of the first layer from the layer of catalyst and the gap. In one example of this invention, the pulsed laser is an excimer laser. The close proximity pulsed laser deposition system of this invention may include a drive mechanism for moving at least one of the mediums and the beam pulse relative to the others. Typically, the layer of catalyst may be metal, such as a noble metal chosen from the group consisting of copper, silver, gold, nickel, palladium, platinum, rhodium and iridium. The gap may contain a gas such as air or argon.

In a preferred embodiment, the coating includes a finely divided weblike network of particles. In one example, the particles are approximately three nanometers in diameter or less. Ideally, the fluence of the beam pulse is in the range of about 0.5 to 1.5 joules/cm² and has a duration of about 0.5 seconds or less.

In one design, the material on the first medium is up to 0.5 microns in thickness. The first medium may be a polymer, the second medium may include carbon, or perfluorosulfomate polymer. In a preferred design of this invention the coating is approximately 0.04 mg/cm².

This invention further features a close proximity pulsed laser catalyst deposition system for a fuel cell including a first medium containing a layer of catalyst to be deposited, an electrode disposed across a gap from and facing the layer of catalyst to be deposited, the gap being at ambient atmospheric pressure, and a pulsed laser for applying an energy beam pulse above the ablative energy threshold of the catalyst to create a vaporized plume of the catalyst and direct the vaporized plume across the gap at ambient atmospheric pressure to deposit a porous, finely divided coating of increased surface area of the electrode on the second medium.

The electrode may be a cathode or an anode. In one design, the electrode is disposed on one or both sides of a conductive polymer membrane of a fuel cell. In one example, the conductive polymer membrane is sandwiched between the electrode and the anode.

This invention also features a close proximity pulsed laser catalyst deposition system for an electrolyzer including a first medium containing layer of catalyst to be deposited, an electrode medium disposed across a gap from and facing the layer of catalyst to be deposited, the gap being at ambient atmospheric pressure, and a pulsed laser for applying an energy beam pulse above the ablative energy threshold of the catalyst to create a vaporized plume of the catalyst and direct the vaporized plume across the gap at ambient atmospheric pressure to deposit a porous, finely divided coating of increased surface area of the electrode on the second medium.

This invention also features a close proximity pulsed laser method for depositing a catalyst on a medium, the method including the steps of: providing a first medium containing a layer of catalyst to be deposited, providing a second medium disposed across a gap from and facing the layer of catalyst to be deposited, the gap being at ambient atmospheric pressure, and applying an energy beam pulse above the ablative energy threshold of the catalyst with the pulsed laser to create a vaporized plume of the catalyst and direct the vaporized plume across the gap at ambient atmospheric pressure to deposit a porous, finely divided coating of increased surface area of the catalyst on the second medium.

In one embodiment, the ambient atmospheric pressure may include atmospheric and near atmospheric pressure. In one example, the gap may be less than approximately one centimeter. In other designs, the gap is approximately one millimeter or less. The first medium may be transparent at the wavelength of the pulsed laser. The catalyst may be a metal chosen from the group consisting of copper, silver, gold, nickel, palladium, platinum, rhodium and iridium. Ideally, the gap contains a gas, such as air. In a preferred embodiment, the coating may be approximately 0.04 mg/cm².

This invention further features a close proximity pulsed laser cell method for depositing a catalyst on a medium of a fuel cell, the method including the steps of: providing a first medium containing a layer of catalyst to be deposited, providing an electrode disposed across a gap from and facing the layer of catalyst to be deposited, the gap being at ambient atmospheric pressure, and applying an energy beam pulse above the ablative energy threshold of the catalyst with pulsed laser to create a vaporized plume of the catalyst and direct the vaporized plume across the gap at ambient atmospheric pressure to deposit a porous, finely divided coating of increased surface area of the catalyst on the electrode.

In other designs, the close proximity pulsed laser cell method for depositing a catalyst on a medium of an electrolyzer of this invention includes the steps of: providing a first medium containing a layer of catalyst to be deposited, providing an electrode disposed across a gap from and facing the layer of catalyst to be deposited, the gap being at ambient atmospheric pressure, and applying an energy beam pulse above the ablative energy threshold of the catalyst with pulsed laser to create a vaporized plume of the catalyst and direct the vaporized plume across the gap at ambient atmospheric pressure to deposit a porous, finely divided coating of increased surface area of the catalyst on the electrode.

This invention also features a close proximity pulsed laser catalyst deposition system comprising a plurality of first mediums, each of the first medium containing layer of a catalyst to be deposited, a plurality of second mediums, each of the second medium disposed across a gap from and facing the layer of catalyst to be deposited, the gap being at ambient atmospheric pressure, and a plurality of pulsed lasers for applying an energy beam pulses above the ablative energy threshold of the catalyst of each of the plurality first mediums to create vaporized plumes of the catalyst and direct the vaporized plumes across the gap at ambient atmospheric pressure to deposit a plurality of porous, finely divided coatings of increased surface area of the catalyst on each the plurality of second medium. In one embodiment, the coatings may include carbon and platinum.

This invention further features a close proximity pulsed laser catalyst deposition system including a first medium containing layer of a catalyst to be deposited, a second medium disposed across a gap from and facing the layer of catalyst to be deposited, the gap being at ambient atmospheric pressure, a pulsed laser for providing an energy beam pulse above the ablative energy threshold of the catalyst to a predetermined exposure area on the layer of catalyst to create a vaporized plume of the catalyst from that predetermined exposure area across the gap at ambient atmospheric pressure, and a driver device for producing relative motion between the predetermined exposure area on the layer of catalyst and the second medium to selectively deposit a porous, finely divided coating of increased surface area of the catalyst on said second medium.

In a preferred embodiment, the driver device may include a beam steering device for moving the beam to a series of predetermined exposure areas on the layer of catalyst. The driver device may include a drive mechanism for moving said first and second medium relative to each other. The coating may be approximately 0.04 mg/cm².

This invention also features a close proximity pulsed laser catalyst deposition system for a fuel cell including a first medium containing layer of a catalyst to be deposited, an electrode disposed across a gap from and facing the layer of catalyst to be deposited, the gap being at ambient atmospheric pressure, a pulsed laser for providing an energy beam pulse above the ablative energy threshold of the catalyst to a predetermined exposure area on the layer of catalyst to create a vaporized plume of the catalyst from that predetermined exposure area and direct the vaporized plume from that predetermined exposure area across the gap at ambient atmospheric pressure, and a driver device for producing relative motion between the predetermined exposure area on the layer of catalyst and the second medium to selectively deposit a porous, finely divided coating of increased surface area of the catalyst on the electrode.

In a preferred embodiment, the driver device may include a beam steering device for moving the beam to a series of predetermined exposure areas on the layer of catalyst. The driver device may include a drive mechanism for moving the first medium and the electrode relative to each other. The coating may be approximately 0.04 mg/cm². The electrode may be an anode or a cathode.

This invention also features a close proximity pulsed laser catalyst deposition system including a first medium containing layer of a catalysts to be deposited, a second medium disposed across a gap from and facing said layer of catalysts to be deposited, the gap being at ambient atmospheric pressure, and a pulsed laser for applying an energy beam pulse above the ablative energy threshold of the catalysts to create a vaporized plume of the catalysts and direct the vaporized plume across the gap at ambient atmospheric pressure to deposit a porous, finely divided coating of increased surface area of the catalysts on the second medium. In one embodiment, the layer of catalysts may include two or more metals. The metals may be platinum and rhodium, or chosen from the group consisting of copper, silver, gold, nickel, palladium, rhodium and iridium.

### BRIEF DESCRIPTION OF THE DRAWINGS

Other objects, features and advantages will occur to those skilled in the art from the following description of a preferred embodiment and the accompanying drawings, in which:

FIG. 1A is a schematic side view of a typical fuel cell;

FIG. 1B is an exploded view showing the reaction of hydrogen and oxygen with the catalyst layers of the fuel cell shown in FIG. 1A;

FIG. 2 is a schematic side view of a typical electrolyzer;

FIG. 3 is a schematic side view of a prior art membrane electrode assembly of a fuel cell which have been processed as a sequence of layers;

FIG. 4 is a schematic side view of a prior art sputtering method for depositing a catalyst on a membrane;

FIG. 5 is a schematic side view of one embodiment of the close proximity pulsed laser catalyst deposition system of the subject invention;

FIG. 6 is a schematic side view of another embodiment of the close proximity pulsed laser catalyst deposition system of the subject invention;

FIG. 7 is a schematic side view of one embodiment of the close proximity pulse laser catalyst deposition system for a fuel cell in accordance with the subject invention;

FIG. 8 is a flow chart showing the primary steps of the close proximity pulsed laser method for depositing a catalyst on a medium in accordance with this invention;

FIG. 9 is a flow chart showing the primary steps of the close proximity pulsed laser method for depositing a catalyst on an electrode of a fuel cell in accordance with this invention;

FIG. 10 is a flow chart showing the primary steps of the close proximity pulsed laser method for depositing a catalyst on an electrode of an electrolyzer in accordance with this invention;

FIG. 11 is a schematic side view of another design of the close proximity pulse laser catalyst deposition system for depositing a sequence of layers on a membrane cell in accordance with the subject invention;

FIG. 12 is a schematic three-dimension view of yet another design of the close proximity pulse laser catalyst deposition system for selectively depositing a catalyst on a membrane in accordance with this invention;

FIG. 13 is a schematic three-dimensional view of a test apparatus used for one example of the close proximity pulsed laser system of this invention;

FIGS. 14-15 are SEM photographs showing laser deposited platinum on a glass substrate for the test apparatus shown in FIG. 13;

FIGS. 16-17 are SEM photographs showing laser deposited platinum on a carbon black substrate for the test apparatus shown in FIG. 13;

FIG. 18 is a graph showing the effect of laser pulse fluence on catalyst activity;

FIG. 19 is a graph showing fuel cell performance comparing the effects of added laser deposited platinum to electrodes that have no preloaded catalysts;

FIG. 20 is a graph showing the effect of adding a single layer of added laser deposited platinum to electrodes that have no preloaded catalyst already fully loaded at a catalyst level of 1 mg/cm²;

FIG. 21 is a graph showing a series of tests comparing argon and hydrogen exposure atmospheres and the effect of multiple laser deposited platinum coatings;

FIG. 22 is a graph showing fuel cell performance data under standard test conditions for low catalyst loading;

FIG. 23 is a graph showing the current density normalized to catalyst loading;

FIG. 24 is a schematic side view showing the effective coating depth of a sputtered catalyst on a membrane;

FIG. 25 is a graph showing typical catalyst loading effects on a conventional catalyst;

FIG. 26 is a graph showing the normalized current density of the catalyst loading shown in FIG. 25;

FIG. 27 is a graph showing super-linear catalyst loading effect in accordance with the subject invention; and

FIG. 28 is a graph showing the normalized current density of the catalyst loading shown in FIG. 27.

### DISCLOSURE OF THE PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of methods and construction and the arrangements of components set forth in the following description or illustrated in the drawings.

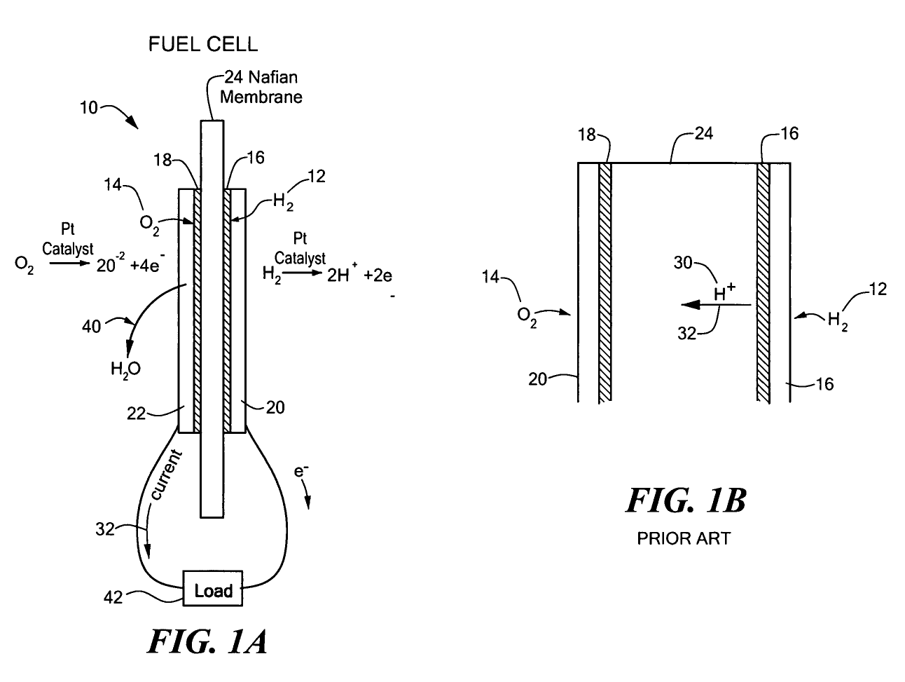

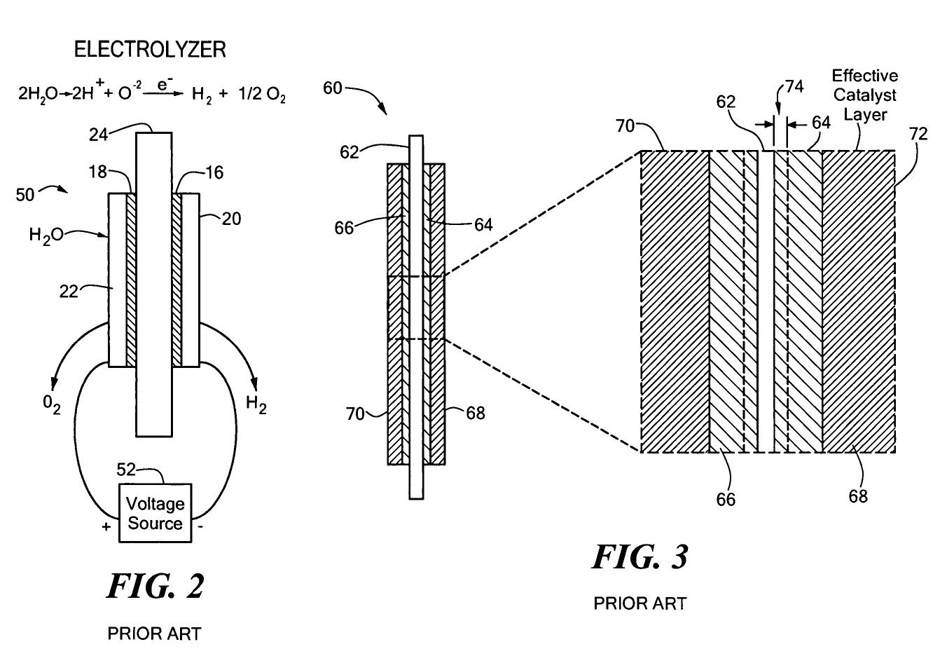

As discussed in the Background section above, fuel cell 10, FIG. 1A provides a controlled reaction of reactants, such as molecular hydrogen 12 and molecular oxygen 14 which are enabled by the presence of a catalyst, e.g., platinum, in the form of catalyst layers 16 and 18. Catalyst layers 16 and 18 are typically supported by carbon paper, such as electrode 20 (e.g., a cathode) and electrode 22 (e.g., an anode), respectively, and membrane layer 24.

As shown in FIG. 1B, molecular hydrogen 12 passes through electrode 20 and reacts with catalyst layer 16 in accordance with:

$${H}_{2} {\to }^{{catalyst}^{Pt}} 2 {H}^{+} + 2 {e}^{-} \qquad ( 1 )$$

As shown by equation (1), molecular hydrogen 12 is ionized to two positively charged hydrogen ions and two electrons. Similarly, molecular oxygen 14 passes through electrode layer 18 and reacts with catalyst layer 18 and undergoes ionization in accordance with the reaction:

$${O}_{2} {\to }^{{catalyst}^{Pt}} 2 {O}^{- 2} + 4 {e}^{-} \qquad ( 2 )$$

resulting in two negatively charged oxygen ions and four electrons.

The positively charged H⁺ ions, e.g., H⁺ ion 30 on the surface of catalyst layer 16 are attracted to negatively charged oxygen ions 28 on the surface of catalyst layer 18 and pass through membrane layer 24 in the direction indicated by arrow 32. When positively charged hydrogen atoms 30 react with negatively charged oxygen atoms 28, water is formed as shown by arrow 38, FIG. 1A. The electrons produced from reaction (1) above are emitted by electrode 20 to generate electrical current in the direction indicated by arrow 32 to drive load 42.

Electrolyzer 50, FIG. 2, reverses the process of fuel cell 10 by converting water to hydrogen and oxygen as shown by:

$$2 {H}_{2} O \to 2 {H}^{+} + {O}^{- 2} {\to }^{{e}^{-}} {H}_{2} + \frac{1}{2} {O}_{2} \qquad ( 3 )$$

Electrolyzer 50 requires voltage source 52 in order to provide sufficient energy for reaction (3).

The primary electrochemical element of a typical commercial fuel cell, such as the PEM fuel, is the membrane electrode assembly 60, FIG. 3. The membrane electrode assembly includes conductive polymer membrane 62, catalyst layers 64, and 66, and carbon paper (or carbon cloth) backing 68, and 70 of similar design of fuel cell 10, FIG. 1.

Typical prior art methods and systems fabricate membrane electrode assembly 60, FIG. 3 as a sequence of layers, as shown in detail in the enlarged view section 72. As explained in the Background section, this prior art method of manufacturing membrane electrode assembly 60 requires complicated and time consuming steps which escalate the cost of production.

Moreover, these methods typically deposit layers of catalyst, e.g., catalyst layers 62 and 64 which are typically 50 μm thick to guarantee sufficient catalyst coverage. However, the optimal thickness of a catalyst layer is actually only the 5 to 10 μm of the catalyst closest to conductive polymer membrane 62, as indicated by arrow 74. The result is that excess expensive catalyst is used, further escalating the cost of the production of the membrane electrode assembly and the fuel cell.

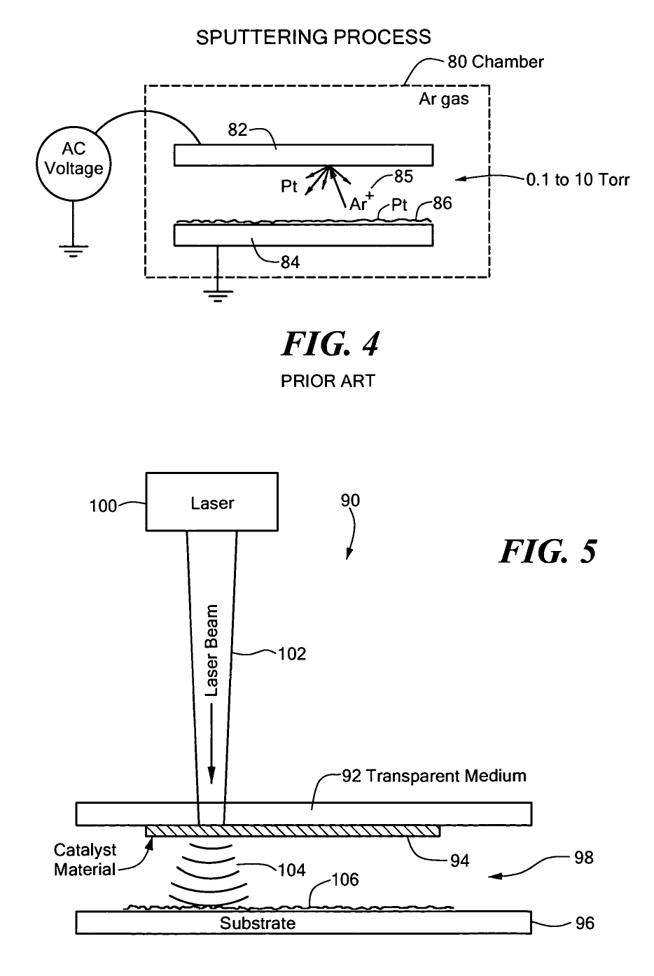

One prior art technique to overcome the problems associated with the excess layer of catalyst material is known as sputtering. As shown in FIG. 4, this method of catalyst deposition utilizes vacuum chamber 80 with an inert gas therein. Typical vacuum conditions range from 0.1 to 10 Torr. The argon gas is ionized to create positively charged argon ion 85 which interacts with catalyst membrane 82, (e.g., platinum) and the sputtered catalysts are deposited on electrode 84 (e.g., a carbon anode) to produce layer of catalyst 86.

Although this technique can produce effective catalyst loading as low as 0.1 mg/cm² and is a dry process step, the high cost associated with sputtering is prohibitive for the mass-production of fuel cells because of the porous nature of the materials associated with making fuel cells.

As discussed in the Background section, other prior techniques such as catalyst ink transfer are also somewhat effective, but the number of process steps is complicated, difficult and time consuming. Prior art pulsed laser deposition techniques are effective but must be performed under moderate to high vacuum conditions which increases the complexity and expense of the technique. Conventional pulse laser deposition methods have not been applied to the deposition of catalyst layers. The goal of conventional pulsed laser deposition methods is to produce solid, high density films, which are not at all suitable for high performance catalysis.

In contrast, close proximity pulse laser catalyst deposition system 90, FIG. 5 of the subject invention includes first medium 92 containing catalyst layer 94 to be deposited, and second medium 96 disposed across gap 98 and facing layer of catalyst 94 to be deposited. Gap 98 is typically at ambient atmospheric pressure, or near ambient atmospheric pressure and contains a gas such as air, or argon. In one design, gap 98 is less than approximately 1 centimeter. In other examples, gap 96 is approximately 1 millimeter or less. Catalyst deposition system 90 further includes pulsed laser 100, such as an excimer laser, for applying energy beam 102 above the ablative energy threshold of catalyst layer 94 to create vaporized plume 104 of catalyst and direct vaporized plume 104 across gap 98 to deposit porous, finely divided coating 106 of increased surface area of catalyst on second medium 96. Ideally, coating 106 is approximately 0.04 mg/cm². In one embodiment, coating 106 includes a finely divided web-like network of particles, to be discussed infra, that are approximately 3 nanometer in diameter or less.

In one design of this invention, catalyst layer 94 may include two or more catalysts, ideally metals, such as Pt or Ru, or any of the metals chosen from the group consisting of copper, silver, gold, nickel, palladium, rhodium and iridium. Pulsed layer 100 applies energy beam 102 above the ablative energy threshold of the two or more catalysts of catalyst layer 94 to create vaporized plume 104 which contains a mixture of the two or more catalysts and which are deposited as porous, finely divided coating 106 of increased surface area of catalysts on second medium 96. The result is that the two or more catalysts are efficiently mixed and applied to the second medium as a finely divided coating of increased surface area which contains the two or more catalysts.

Typically, laser 100 provides a fluence of beam pulse 102 in the range of about 0.5 to 1.5 joules/cm², which is typically applied for 20 nanoseconds or less, to efficiently ablate catalyst layer 94 and create vaporized plume 104 of catalyst.

Close proximity pulse laser catalyst deposition system 90 efficiently deposits a thin layer catalyst material at the optimal thickness of the catalyst layer (i.e., 0.04 mg/cm² of catalyst) on a medium without having to deposit the catalyst as a sequence of layers, utilizing cost prohibitive techniques such as vacuum sputtering, complicated catalyst ink transfer techniques, or pulsed laser system which must be operated under moderate to high vacuum conditions. The result is a time efficient, simple, and innovative method for depositing a catalyst on a membrane, which significantly reduces the cost and amount of catalyst utilized by the system. Moreover, the cost to operate system 90 is reduced because laser 100 requires only 0.5 to 1.5 joules/Cm² to vaporize catalyst layer 94.

In one design of this invention, first medium 92 is transparent at the wavelength of pulsed laser 100. Pulsed laser 100 is typically on the opposite side of first medium 92 from layer of catalyst 94 in gap 98. Ideally, catalyst layer 94 is composed of a metal. Typically the metal is a noble metal chosen from the group consisting of copper, silver, gold, nickel, palladium, platinum, rhodium, and iridium. Catalyst layer 94 on first medium 92 is ideally 0.5 microns or less. In one example, first medium 92 is a polymer and second medium 96 includes carbon. Second medium 96 may also include perfluorosulfonate polymer.

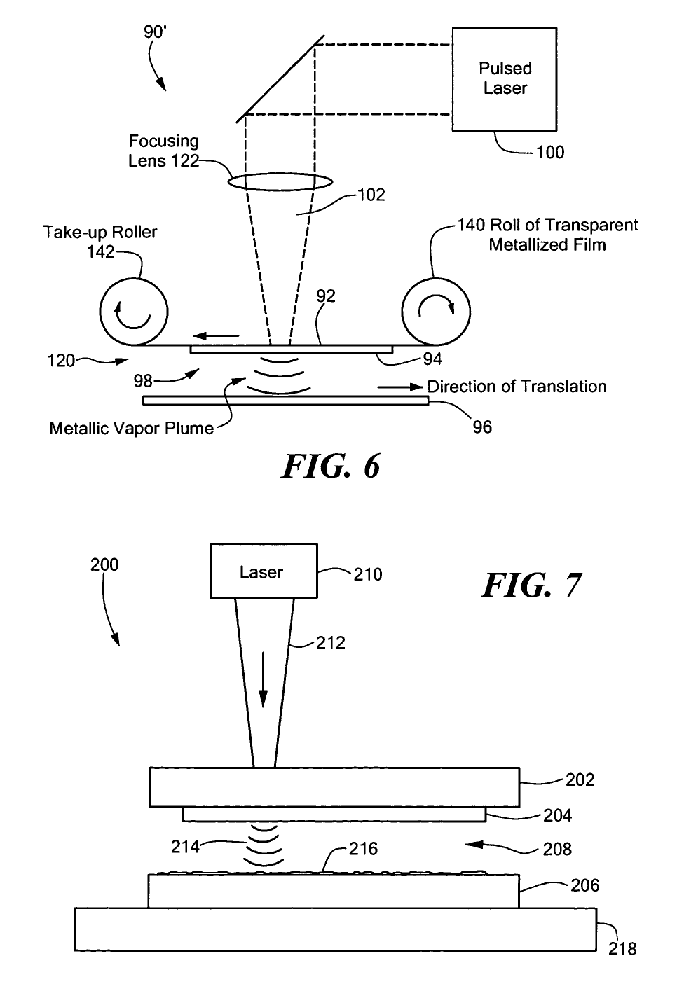

In one design of this invention, close proximity pulsed laser catalyst deposition system 90′, FIG. 6, where like parts have been given like numbers, includes drive mechanism 120 for moving first medium 92 with catalyst layer 94 in relation to pulsed laser 100. Drive mechanism 120 may include roll 140 for dispensing first medium 92 with catalyst layer 94 and take up roller 142 for receiving medium 92. Although as shown in FIG. 6, drive mechanism 120 moves first medium layer 92 with catalyst relative to pulsed laser 100 and second medium 96, this is not a necessary limitation of this invention, as drive mechanism 120 may be configured to provide for moving pulsed laser 100, first medium 92, or second medium 96 relative to each other. System 90′ may also include focusing lens 122 for focusing laser beam 102 on first medium 92.

In another design of this invention, close proximity pulse laser catalyst deposition system 200 for a fuel cell, FIG. 7, includes first medium 202 containing a layer of catalyst 204 to be deposited, and electrode 206 disposed across gap 208 and facing layer 204 of catalyst to be deposited. Gap 208 is typically at ambient atmospheric pressure. System 200 further includes pulsed laser 210 for applying energy beam 212 above the ablative energy threshold of catalyst layer 204 to create vaporized plume 214 of the catalyst and direct vaporized plume 214 across gap 208, at ambient atmospheric pressure, to deposit porous, finely divided coating 216 of increased surface area on electrode 206. Electrode 206 may be a cathode or an anode. Typically, electrode 206 is disposed on proton conductive polymer membrane 218 of a fuel cell. In one example, proton conductive polymer 218 is sandwiched between an electrode and an anode, not shown. Ideally, gap 208 is approximately 1 centimeter, however, in other designs gap 208 is a millimeter or less. Ideally, first medium 202 is transparent at the wavelength of pulsed laser 210. System 200 may similarly include a drive mechanism of similar design to drive mechanism 120, FIG. 7 for moving at least first medium 202, electrode 218, and pulsed laser 210 relative to each other. Similar to close proximity pulsed laser catalyst deposition system 90, FIGS. 5 and 6, the layer of catalyst is a metal chosen from the group consisting of copper, silver, gold, nickel, palladium, platinum, rhodium, and iridium. Ideally, gap 209 contains a gas such as air. In a preferred embodiment, coating 216 is approximately 0.4 mg/cm². Ideally, coating 216 is approximately 5 μm to 10 μm in thickness. In another example of this invention, close proximity pulsed laser deposition system 200 is modified for an electrolyzer (not shown).

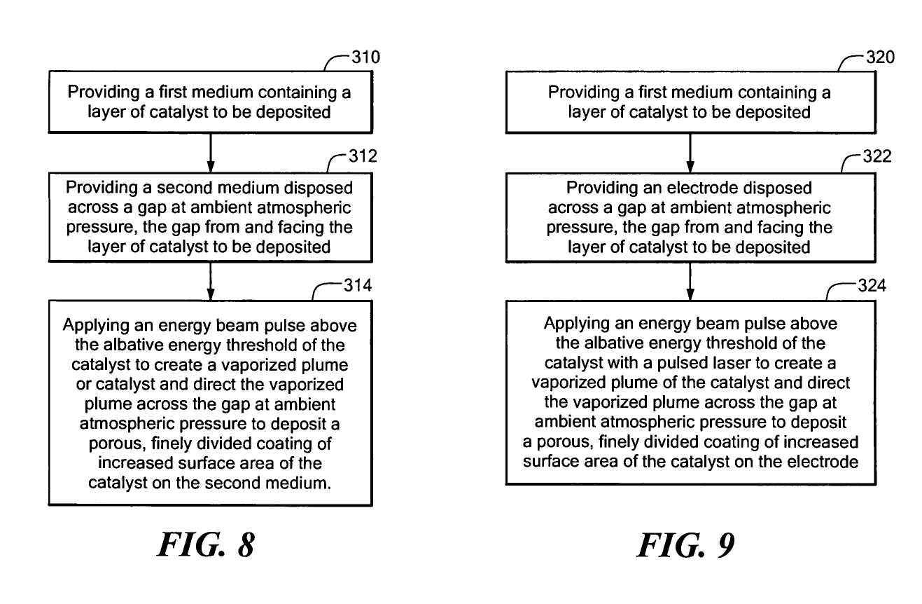

The close proximity pulsed laser method for depositing a catalyst on a medium of this invention includes the steps of: providing a first medium 92, FIG. 5, containing layer 94 to be deposited, step 300, FIG. 8; providing second medium 96, FIG. 5 across gap 98 at ambient atmospheric pressure, gap 98 from and facing layer of catalyst 94 to be deposited, step 312, FIG. 8; applying energy beam 102, FIG. 5 above the ablative energy threshold of catalyst layer 94 with pulsed laser 100 to create vaporized plume 104 of catalyst 94 and directing vaporized plume 104 across gap 98 at an ambient atmospheric pressure to deposit porous finely divided coating 106 of increased surface area of catalyst 94 on second medium, step 314, FIG. 9.

The close proximity pulsed laser method for depositing a catalyst on a medium of a fuel cell of this invention includes the steps of: providing first medium 202, FIG. 7 containing layer 204 to be deposited, step 320, FIG. 9; providing electrode 206, FIG. 7 across gap 208 at ambient atmospheric pressure, gap 208 from and facing layer of catalyst 204 to be deposited, step 322, FIG. 9; applying energy beam 212, FIG. 7 above the ablative energy threshold of catalyst layer 204 with pulsed laser 210 to create vaporized plume 214 of catalyst 204 and directing vaporized plume 214 across gap 208 at an ambient atmospheric pressure to deposit porous finely divided coating 216 of increased surface area of catalyst on electrode 206, step 324, FIG. 9. Typically, electrode 206 may be an anode or a cathode.

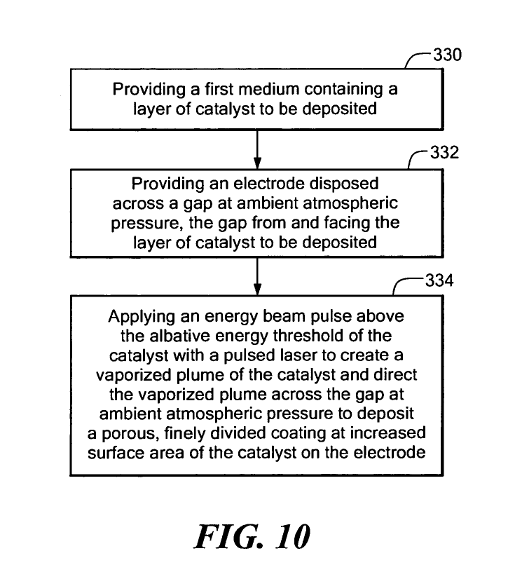

The close proximity pulsed laser method for depositing a catalyst on a medium of an electrolyzer in accordance with this invention includes the steps of: depositing first medium 202, FIG. 7 containing layer 204 to be deposited, step 330, FIG. 10; providing electrode 206, FIG. 7 across gap 208 at ambient atmospheric pressure, gap 208 from and facing layer of catalyst 204 to be deposited, step 332, FIG. 10; applying energy beam 212, FIG. 7 above the ablative energy threshold of catalyst layer 204 with pulsed laser 210 to create vaporized plume 214 of catalyst 204 and directing vaporized plume 214 across gap 208 at an ambient atmospheric pressure to deposit porous finely divided coating 216 of increased area of catalyst on electrode 206, step 334, FIG. 10. Typically, electrode 206 of the electrolyzer may be an anode or a cathode.

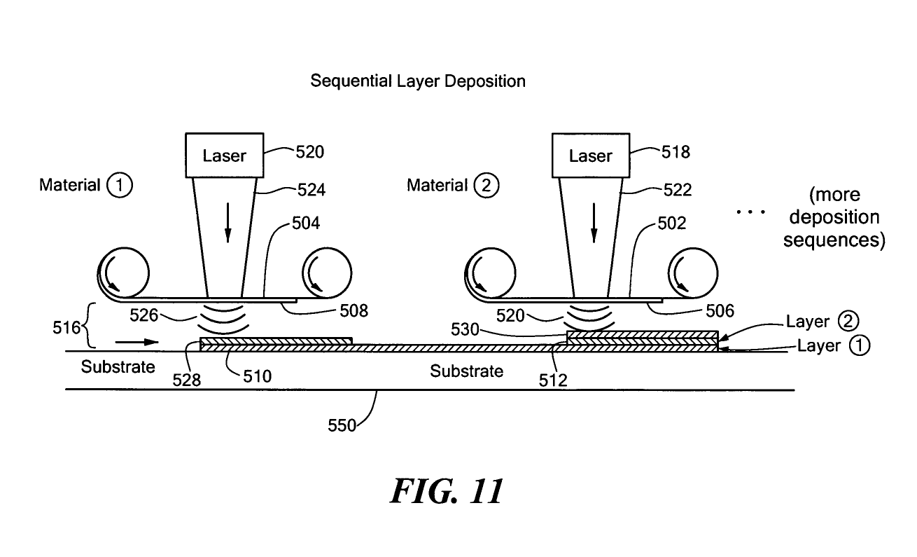

In one embodiment, close proximity pulsed laser catalyst deposition system 500, FIG. 11 includes plurality of first mediums 502 and 504, each medium 502 and 504 containing layer 506 and 508, respectively, of a catalyst to be deposited. System 500 further includes plurality of second mediums 510 and 512, each second medium 512 and 514 disposed across gap 516, ideally at ambient atmospheric pressure, from and facing layers of catalyst 506 and 508 to be deposited. System 500 further includes plurality of pulsed lasers 518 and 520 for applying energy beam pulses 522 and 524 above the ablative energy threshold of the catalyst of each of first mediums 502 and 504 to create vaporized plumes 520 and 522 of the catalyst and direct vaporized plumes 520 and 522 across gap 516 at ambient atmospheric pressure to deposit porous, finely divided coatings 528 and 530 of increased surface area of said catalyst on second mediums 510 and 512, respectively. The unique design of system 500 provides for deposition of sequential layers to be deposited (e.g., coatings 528 and 530) on second mediums 510 and 512, respectively, typically disposed on membrane 550, thereby building up a layered structure in a carefully engineered manner which maximizes the effectiveness of the precious metal (reducing waste and cost) and allow tailoring the catalyst loading to match the fuel cell application for maximum cost-effectiveness. This unique feature is not possible in the prior art, because wet process approaches to deposition are difficult to control at the required thickness level and sputtering is too expensive to consider for multiple layer processes and mass production.

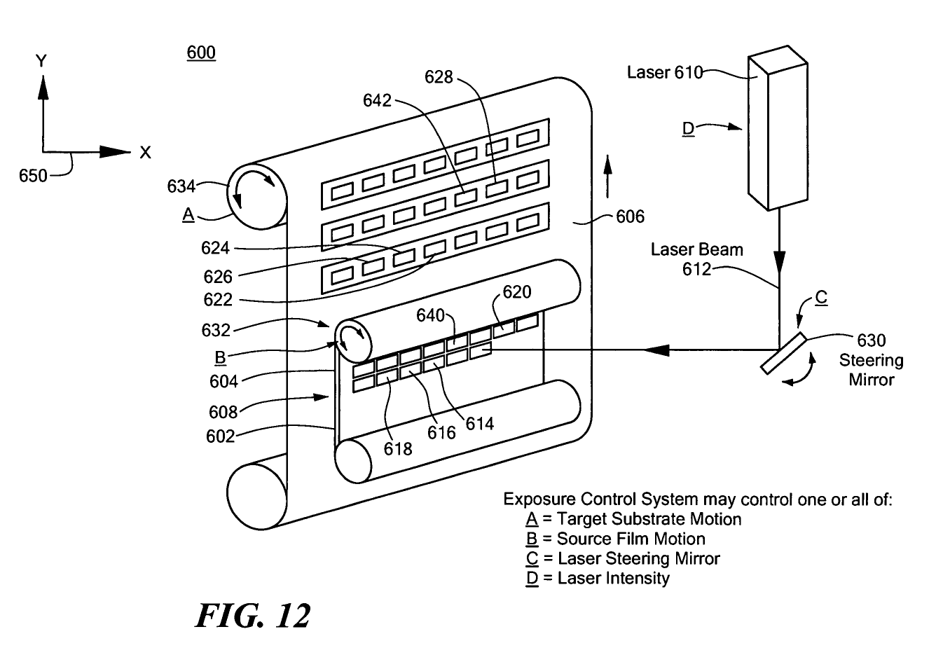

Close proximity pulsed laser catalyst deposition system 600, FIG. 12 includes first medium 602 containing catalyst layer 604 to be deposited, and second medium 606 disposed across gap 608 and facing layer of catalyst 604 to be deposited. In one design, as utilized in a fuel cell, second medium 606 may be an electrode, such as an anode or a cathode. Gap 608 is typically at ambient atmospheric pressure, or near ambient atmospheric pressure and, similar to the designs above, typically contains a gas such as air, hydrogen, or argon. System 600 further includes pulsed laser 610 for applying energy beam 612 above the ablative energy threshold of catalyst layer 604 to predetermined exposure area 614 on catalyst layer 604 to create a vaporized plume of catalyst from predetermined exposure area 612 and direct the vaporized plume from predetermined exposure area 614 across gap 608 at ambient atmospheric pressure. System 600 also includes a driver device for producing relative motion between predetermined exposure area 614 on catalyst layer 604 and second medium 606 to selectively deposit porous, finely divided coating 622 of increased surface area of catalyst on second medium 606. Ideally, coating 106 is approximately 0.04 mg/cm².

In one embodiment, the driver device may include a beam steering device, such as steering mirror 630, for moving beam 612 to a series of predetermined exposure areas on catalyst layer 604 of first medium 602, such as predetermined exposure areas 614, 616, 618, 620, and 640. In other designs, the driver device may include a drive mechanism 632 and/or drive mechanism 634 for moving first medium 602 and second medium 606 relative to such that beam 612 is applied to predetermined exposure areas, e.g., predetermined exposure areas 614, 616, 618, 620 and 640.

The result is that system 600 spatially controls the locations where a porous, finely divided coating of increased surface area of catalyst is applied to second medium 606, without the need for masks as found in the prior art. For example, when beam 612 is directed by steering mirror 630 such that beam 612 is applied above the ablative energy threshold of the catalyst to predetermined exposure area 614, a vaporized plume of catalyst is created and directed from predetermined exposure area 614 such that a coating of catalyst is selectively deposited on second medium 606 at area 622 (area 622 is shown after second medium 606 has been translated in the Y-axis direction (as shown by graph 650) by drive mechanism 634). Steering mirror 630 may then move beam 612 such that beam 612 is applied to predetermined exposure area 616, and the resulting selective deposit of porous, finely divided coating of increased surface area of catalyst on second medium 606 will be produced at area 624 (also shown after translation of second medium 606 in the Y-axis direction). Similarly, steering mirror 630 may direct beam 612 to predetermined exposure areas 618 and 620, which results in a selective deposit of porous, finely divided coating of increased surface area of catalyst on second medium 606 at areas 626 and 628, respectively. In other examples, first medium 602 and second medium 606 may be translated between exposures of beam 612 by drive mechanism 632 and/or drive mechanism 634 to produce relative motion between predetermined exposure areas on catalyst layer 604 of first medium 602. For example, translating first medium 602 in the Y-axis direction with drive mechanism 632 will result in beam 612 being applied above the ablative energy threshold at predetermined exposure area 640 and a vaporized plume of catalyst is and directed from predetermined exposure area 640 such that a coating of catalyst is selectively deposited on second medium 606 at area 642 (shown after translation of second medium 606 in the Y-axis direction). Although as shown in FIG. 12, the drive mechanism moves first medium 602 and second medium 606 in the Y-axis direction, this is not a necessary limitation of this invention, as the drive mechanism may also move in the Y-axis direction.

### EXAMPLES

The following examples are meant to illustrate and not limit the present invention.

### Substrate Deposition

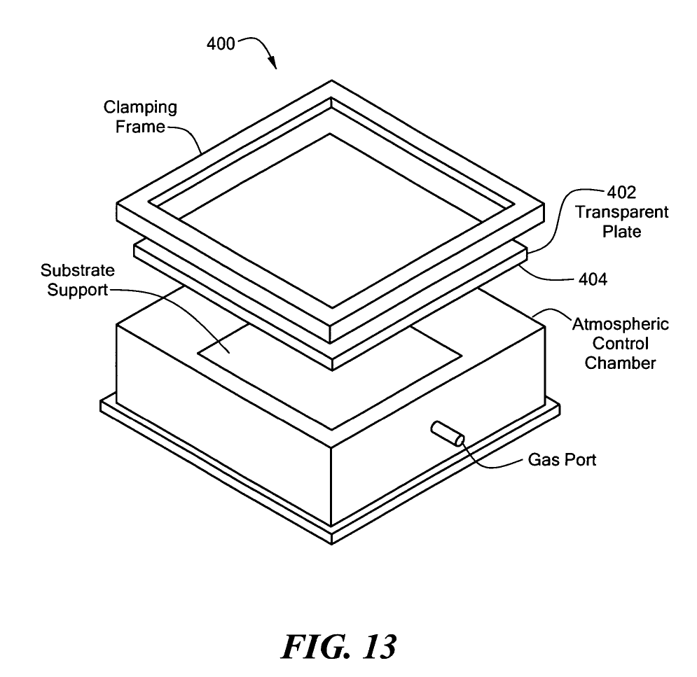

Experimental exposures in accordance with this invention were carried out using the test apparatus 400, FIG. 13. Evaporated Pt layers 20 nm thick were deposited on thin fused silica windows 402. (The fused silica was not antireflection coated.) With Pt layer facing downward indicated by arrow 404, apparatus 400 was sealed and flushed with the selected gas. Various substrates could be loaded before sealing and spaced at any distance from the Pt layer from 0 to 25 mm. Once flushed, apparatus 400 was sealed and mounted for exposure by the excimer laser (not shown). The wavelength of the laser used was at 248 nm because of the availability of equipment at Resonetics, Inc., Nashua, N.H. The exposure pattern used was a standard step and repeat field approximately 5 by 2 mm. A small space between exposure fields (0.05 mm) was left to avoid double exposure. Exposure patterns were entirely controlled by computer and were very flexible. The largest exposure pattern used in these experiments was 75 by 75 mm.

### Visual Observations

The first observations showed that the laser exposure process was meeting expectations readily. A single laser pulse was sufficient to cleanly remove the Pt. A safe minimum exposure threshold was approximately 250 mJ/cm². Exposure at a nominal 200 mJ/cm² showed only partial removal of the Pt layer and was clearly sensitive to the uniformity of the exposure field. Efficient and clean removal of the Pt layer was maintained up to an exposure fluence of 750 mJ/cm². At 1 J/cm², scattered and reflected light had a tendency to remove Pt from adjacent exposure fields. No exposures were attempted at fluences higher than 1.5 J/cm². In accordance with this invention it was discovered that the fused silica substrates could be readily cleaned and coated again with new Pt layers for further exposures. Very modest surface damage to the fused silica was visually observed, but is believed to provide no substantive change associated with these exposure conditions.

### Source to Substrate Spacing

The initial exposures in accordance with this invention were performed while using an argon atmosphere at normal atmospheric pressures. Depositions were initially carried out on clean glass substrates so as to obtain a visual estimate of the deposition process viability. Initial exposures were at 250 mJ/cm². Depositions on the glass quickly indicated that the spacing of the substrate had a major impact on the Pt particle size generated. While the initial evaporated Pt film on the fused silica was nearly opaque, at a spacing of 1 cm the Pt on the substrate was barely visible to the naked eye. Viewing with an optical microscope indicated the presence of some fairly large (micron sized) particles. This indicates that the particle sizes were rather large and therefore had only a modest surface area. (Large reactive surface area is generally considered beneficial to catalytic activity.)

The spacing was reduced to less than 1 mm and the deposited Pt was much more visible. Examination with an optical microscope suggested that the particle size was noticeably reduced. This provides results that are potentially promising, but since the desired particle sizes are more likely to be in the range of a few nanometers, optical observations can only provide limited guidance.

A minor disadvantage of the close spacing was that the small non-uniformities in the exposure fluence were readily replicated in the deposited Pt layer. This suggests that higher uniformity could be fostered by more attention to laser beam optical design.

Based on these results, all further testing in accordance with this invention was performed with the substrates in very close proximity to the source (less than 1 mm). While this seemed to contradict expectations from literature references, the inventor hereof chose to follow his own observations.

### SEM Observations

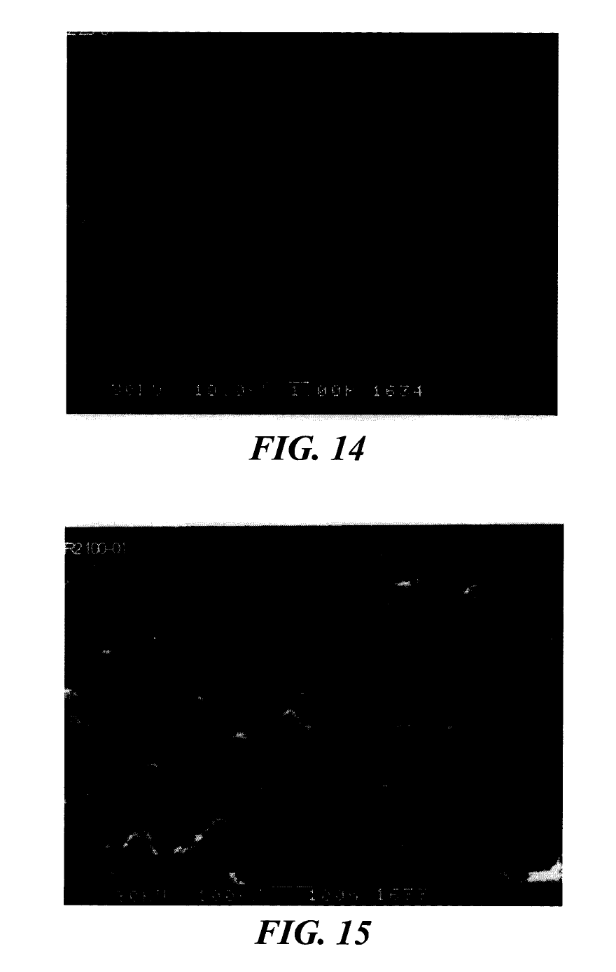

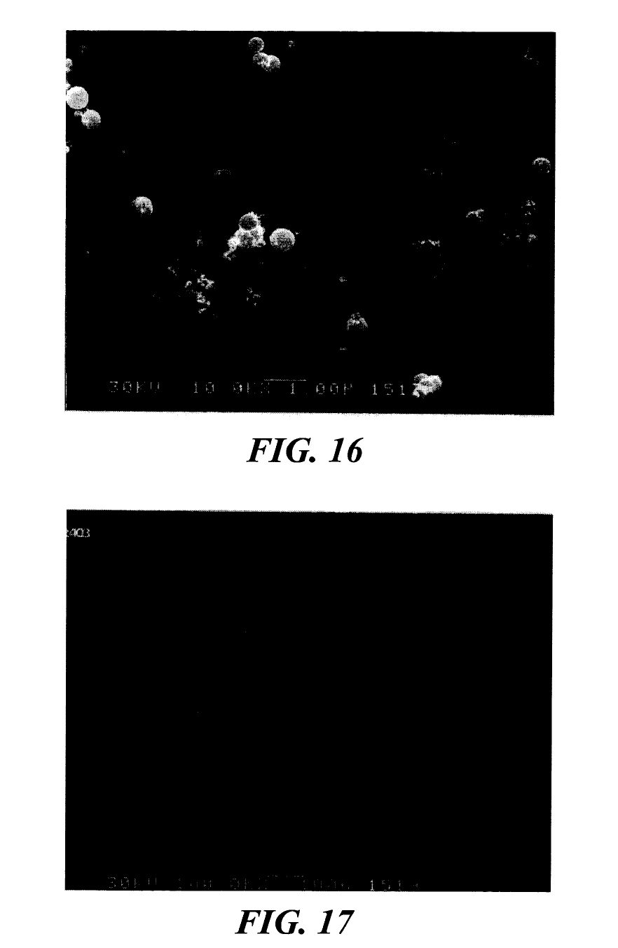

The visual observations were followed up by SEM measurements of the deposited material both on glass substrates and on carbon layers equivalent to our standard fuel cell electrodes without the catalyst layer. Some of the images obtained are shown in the following figures. The results are interesting on several key points. The deposited Pt appears to be a mixture of many very fine particles and far fewer large round spherical particles, as shown in FIG. 14. It is likely that the many fine particles will be the most productive ones for enhanced catalytic activity. Deposition at higher pulse fluence 750 mJ/cm² to 1 J/cm² resulted in a reduced presence of the larger Pt spheres, as shown in FIG. 15. The inventor hereof interprets this as an indication that more of the tiny Pt particles are generated. An extremely fine “web” of Pt is present when the deposition is on the carbon electrodes, as shown in FIGS. 16 and 17. This is a unique feature that will be discussed in detail below. The existence of this web may be very beneficial in enhancing catalytic activity and may be a new physical structure for platinum. Taken collectively, these results suggest that close spacing and high laser power is probably beneficial to providing the best catalysts.

### Cyclic Voltametry Measurements

It was also observed that the catalyst effectiveness (determined through cyclic voltametry (CV)¹²) indicated a significant dependence of our catalyst upon details associated with Nafion solution treatment. The effective surface area of the catalyst, which is a measure of the efficiency of the catalyst, depended on a combination of the deposition environment (laser pulse energy and resident atmosphere) and post deposition treatment of the electrode.

### Fuel Cell Performance

The majority of experimental testing was carried out on laser Pt deposited on fuel cell electrodes that are produced using the close proximity pulsed laser deposition system of this invention. After the laser Pt deposition, a 20 nm metallic layer of Pt corresponds to a catalyst loading of 0.04 mg/cm², a Nafion solution was brushed onto the surface, and then dried and hot-pressed to Nafion 115 membrane using the close proximity pulsed laser deposition system of this invention. All the electrodes were used as the cathode in cell testing. Since other researchers have already established that anode catalyst loadings can be made very low, typically less than 0.1 mg/cm² by a variety of means, the more challenging test to low loading catalyst quality is as the cathode catalyst layer.

### Testing Conditions

There are no standard test conditions used by the fuel cell industry, therefore the inventor hereof chose to define a set of test conditions as standard. Testing conditions were set at 50 psig H₂/O₂, unhumidified reactants, at 75° C. with “nearly” dead-ended operation. (Almost no excess reactant flow to the cell.) These conditions were selected because they are extremely reproducible and easily duplicated by those skilled in the art, and can be matched with a minimum of supporting equipment. The electrode fabrication process was not altered throughout the testing. While modifications to the standard process might provide improved results, the inventor hereof decided to leave that variable untouched at present to allow straightforward comparative data analysis. All of the quantitative results presented are on 50 cm² active area single cells.

### Parameters Examined

More than 30 samples were prepared in accordance with this invention and were tested under the conditions described above. The entire focus was on the properties of the cathode, since this is the more sensitive test of catalytic quality. In each case a single deposition catalyst loading of the laser deposited Pt corresponds to 0.04 mg/cm². The electrode fabrication procedures that were varied include the following items in a matrix that allowed us to comparatively examine the relative merits of each variable.

Laser pulse fluence was examined at 0.25, 0.75, 1 and 1.5 J/cm². Pre-loading of the electrode with conventional catalyst was done at nominal loadings of 0.0, 0.05, 0.10, 0.4, and 1.0 mg/cm². In each case the catalyst layer thickness was maintained at 50 microns and the loading was altered by selecting commercially available catalysts with different Pt/C weight ratios. The exposure atmosphere was always at atmospheric pressure. The three exposure gases were argon (99.999%), air (room air) and hydrogen (99.999%). Laser Pt loading was varied by making one, two, or three depositions of the laser deposited platinum. This resulted in an equivalent loading of 0.04, 0.08 and 0.12 mg/cm² respectively. In an attempt to determine if the laser heating of the already deposited Pt played a role, a single experiment was carried out where already deposited Pt (0.08 mg/cm²) was submitted to another pass of the laser beam at 750 mJ/cm².

### Results

In order to simplify the description of the results, the inventor hereof delineates the primary quantitative and qualitative trends observed and highlights the key data that defines the performance achieved so far. The primary result of interest, however, is when the proper conditions are selected, the catalytic activity seems to be quite high, comparable with the best published results.

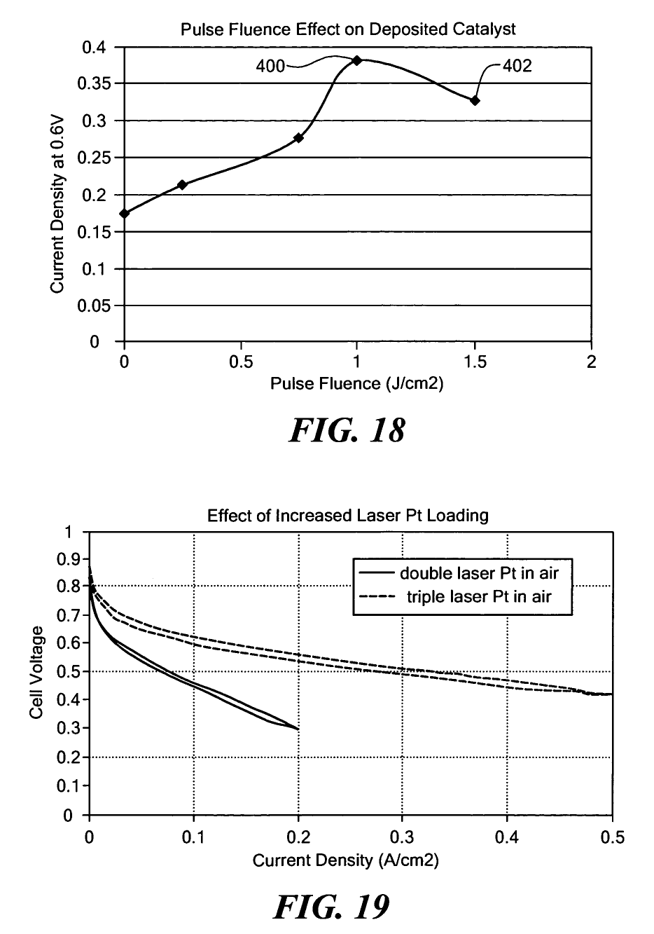

The trend in laser deposition is that higher pulse fluence was better. As shown in FIG. 18, the fuel cell performance improved significantly as the pulse fluence was increased from 0.25 to 1 J/cm², but then seemed to plateau at 1 J/cm², as indicated at 400, showing little change at 1.5 J/cm², as shown at 402. This was not in accordance with original expectations. Coupled with the realization that a close spacing between source and substrate seems preferable, the action of the resident atmosphere does not seem to provide the effect originally predicted. Lower pulse energy should have enabled rapid condensation into small particles in the intervening gas thus enhancing catalytic performance. Instead, the inventor hereof discovered that lower pulse fluence seems to allow for the formation of more 0.1 to 1 micron sized spherical particles and therefore less of the extremely fine nanometer sized material, as shown in FIG. 17. Providing a high energy to the Pt as it is being transferred to the substrate in accordance with this invention provides the best results.

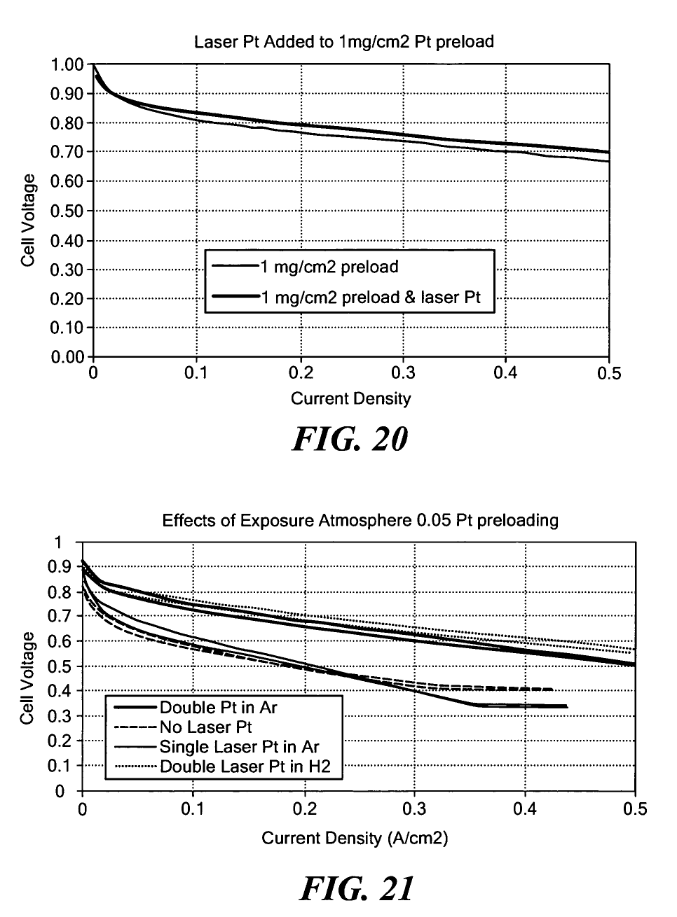

In every example it was found that the addition of the laser deposited Pt enhanced the fuel cell performance. Furthermore, it was found that the performance benefit obtained by the laser deposited platinum was always much higher than the per milligram performance of the preloading. See FIGS. 19, 20, and 21. This is in direct agreement with previously reported results for platinum deposited by sputtering. The interpretation of this observation by the inventor hereof is that the most effective region of the catalyst layer is within less than 10 microns of the surface. If this is true, less than 20% of the 50 micron thick catalyst layer is truly effective. (The catalyst layer is maintained at this thickness for practical reasons related to the “wet transfer process” means for depositing the conventional catalyst.) Adding catalyst to the electrode surface through laser deposition places the catalyst in an optimal location.

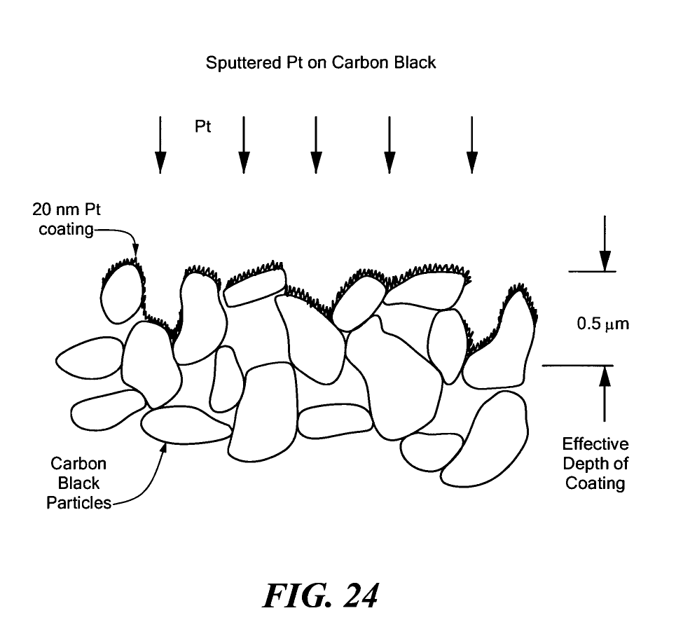

However, the use of only surface deposited catalyst did not provide the best performance. Rather, it was found that superior performance was achieved if there was some catalyst present “in depth” as well as the laser deposited catalyst on the surface. This was true whether the fuel cell performance data was examined directly as standard polarization plots or adjusted to reflect the effectiveness of the catalyst on a per milligram basis as shown in FIG. 23. This matched the qualitative results previously reported for sputter deposited Pt electrodes. When sputter deposited, the surface platinum layer was observed to penetrate no more than 0.5 microns into the carbon black gas diffusion layer (GDL), as shown in FIG. 24. See Ticianelli, E. A., J. G. Beery, et al. (1991). “Dependence of Performance of Solid Polymer Electrolyte Fuel Cells with Low Platinum Loading on Morphologic Characteristics of the Electrodes.” Journal of Applied Electrochemistry, 21: 597-605, incorporated herein by reference. This argues that the best electrode performance is achieved when the catalyst layer is thicker than 0.5 microns but probably less than 10 microns. (How the optimal catalyst layer thickness can be achieved will be discussed further below.) From SEM observations as shown in FIGS. 14-17, the laser deposited Pt in accordance with this invention is similarly confined to a surface region of roughly 0.5 microns.

The three exposure atmospheres were compared and it was determined that hydrogen provided the best results. Argon and air provided very similar performance in the best cases, but air had a tendency to show results that were occasionally inconsistent. This suggests that the primary influence of the atmosphere was chemical rather than density, thermal conductivity, or molecular weight related. In particular, hydrogen was selected, because a common procedure in the preparation of catalysts is that a chemical reduction step is often one of the last process steps. Since the vaporization of the Pt by the laser in accordance with this invention is the only step, it may be advantageous to carry out the process in a reducing atmosphere. The fact that hydrogen is also the lowest molecular weight gas is also noted. Hydrogen is certainly a convenient gas to use as it can be readily produced quite inexpensively, and it can be rendered quite safe to use in most conditions by mixing it with nitrogen (forming gas).

It was initially not known what would be the correct optimal catalyst loading at the surface of the electrode for the best results. Selecting a 20 nm evaporated film (corresponding to a loading of 0.04 mg/cm²) was based on optical arguments. Therefore, the inventor hereof chose to multiply the effect by simply adding more laser deposited catalyst layers sequentially. The inventor hereof discovered that the catalytic effectiveness of additional layers was greater than that of the first layer. (See FIGS. 19 and 21.) A linear effect of catalyst loading and fuel cell performance would have suggested that the catalyst particles were independent and new catalyst was as good as the older catalyst. A sub-linear effect would have suggested that the surface layer was becoming saturated and that catalytic activity of additional Pt was having a limited impact.

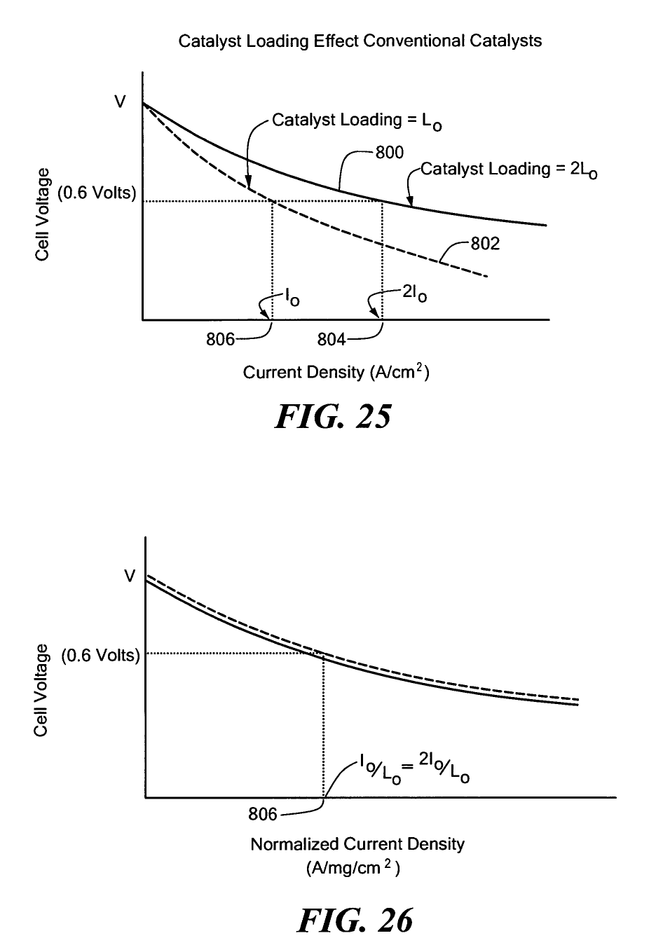

Typical prior art catalyst loading exhibits linear behavior. For example, as shown in FIG. 25, when a 0.6 V cell voltage is generated by a membrane with catalyst loading of L₀ and 2L₀, as indicated at 800 and 802, respectively, the resulting current densities I₀ and 2I₀, as indicated at 804 and 806, respectively, exhibit linear behavior. The normalized current densities of the graph of FIG. 25 as shown in FIG. 26 indicated that at 0.6 V the normalized current densities for loading of L₀ and 2L₀ are I₀/L₀, and 2I₀/2L₀, as indicated at 806, further showing the linear behavior of prior art catalyst loading.

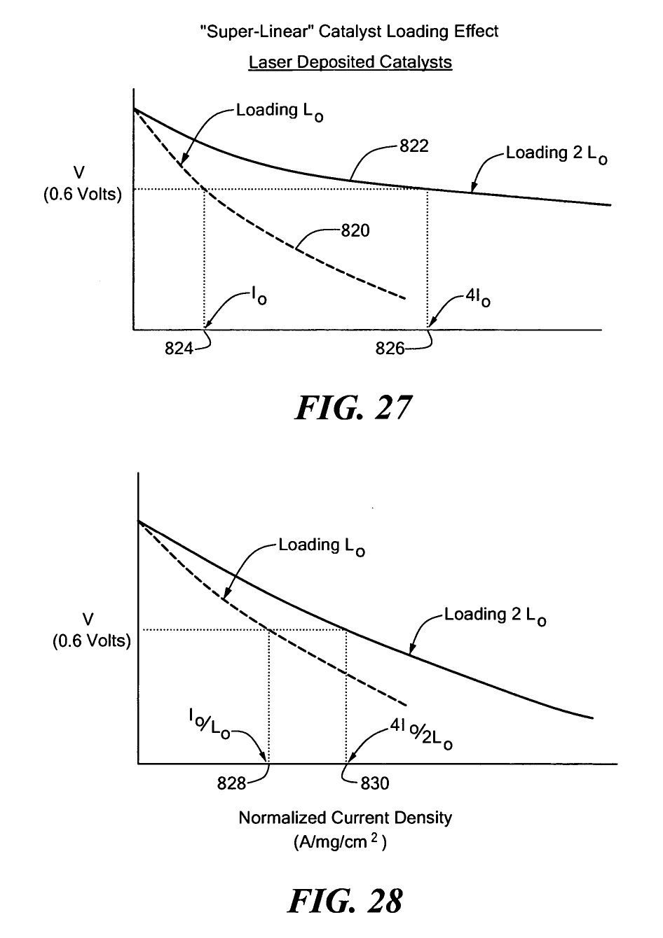

Instead, the inventor hereof observed a “super-linear” effect which exhibits unique results in accordance with this invention. As shown in FIG. 27, when a 0.6 V cell voltage is applied is applied to a membrane with catalyst loading of L₀ and 2L₀, as indicated at 820 and 822, respectively, the resulting current densities I₀ and 4I₀, as indicated at 824 and 826, respectively, exhibit a non linear, or super-linear behavior. The normalized current densities of graph FIG. 27, as shown in FIG. 28 indicate that at 0.6 V the normalized current densities for loading of L₀ and 2L₀ are I₀/L₀, and 4I₀/2L₀, indicated at 828 and 830, respectively, further showing super linear behavior of the catalyst loading in accordance with this invention.

The super-linear behavior suggests that the additional Pt is not adding to the surface in an independent manner, but somehow the addition is greatly enhancing the effect of the catalyst already there. How this is accomplished is suggested by two possible scenarios.

Additional Pt atoms are being added to clusters that are initially too small to be chemically active catalysis sites. This is possible if the Pt vapor cools rapidly enough to inhibit atomic motion across the surface of the carbon particles. Adding more Pt increases the effectiveness of Pt particles that are too small.

Added Pt serves to interconnect existing Pt particles by enhancing the creation of a metallic Pt “web”. Such a fine web structure was observed in the SEM photos shown in FIGS. 16 and 17 and may play a significant role in catalytic activity. Besides being a very high surface area structure (beneficial for catalysis), the web may also enhance the transport of protons across the surface to the location of attached oxygen atoms. See McBreen, J. (1985). “Voltametric Studies Of Electrodes In Contact With Ionomeric Membranes.” Journal of the Electrochemical Society 132(5): 1112-1116, incorporated herein by reference. Adding further Pt may make the interconnections stronger and more numerous in a non-linear manner.

A single test was aimed at determining whether the high catalytic activity was at least partially due to the direct heating of the carbon surface by the laser. This test did not provide any significant benefit to the catalytic activity of the laser deposited Pt. The inventor hereof concludes that the principal benefit comes from the heating of the Pt during deposition.

An examination of the results is best viewed with respect to the performance at low catalyst loadings since this provides the best assessment of catalyst activity on a per milligram basis. To accomplish a quantitative comparison of results, the inventor hereof chose to normalize the results with respect to the Pt content of the electrode. The highlights of the results in accordance with this invention include that the laser deposited catalyst has a performance that is among the best when compared with similar data reported in the literature, and the best results by the inventor hereof was obtained from a combination of laser deposited platinum over an electrode that has already received a low catalyst loading via conventional means.

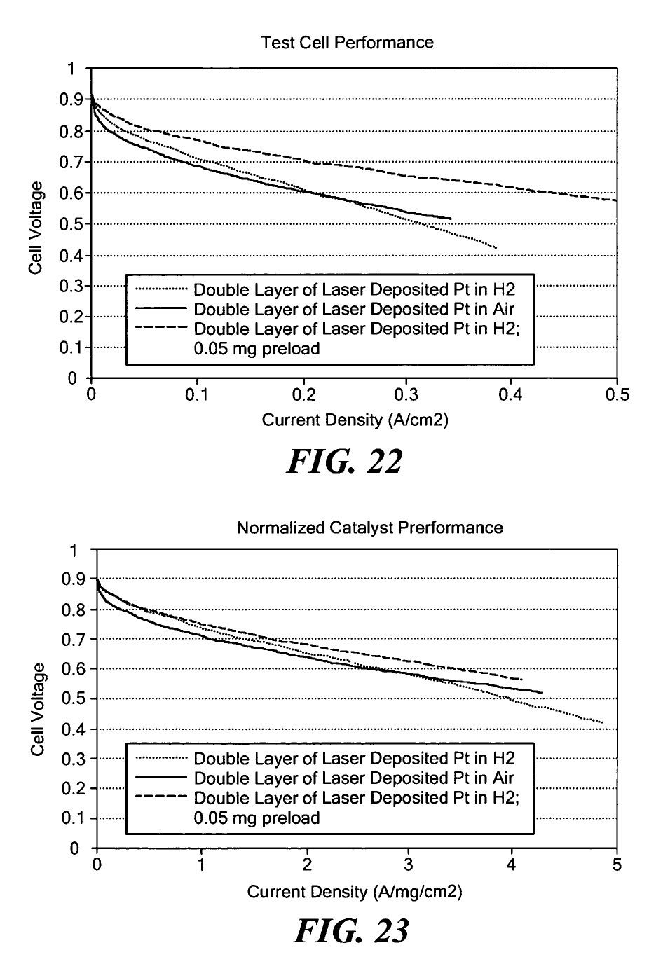

A comparison with previously published data is performed where the performance on a per mg/cm² basis is reported at 0.7 and 0.6 Volts. The fact that the best results in accordance with this invention are from a combination of conventional and laser deposited catalyst is both consistent with previously reported results and indicative that the catalyst layer needs to have more thickness than just a surface layer only 0.5 microns thick, as shown in FIG. 22. Prior art procedures are specifically aimed at concentrating the catalyst in a layer roughly 5 microns thick, rather than the more conveniently processable 50 microns used by most prior art methods. This strongly suggests that the thickness and perhaps even the concentration profile of the catalyst layer is key to maximizing efficient catalyst utilization. This is a particularly valuable conclusion for the inventor hereof because the close proximity pulsed laser catalyst deposition system and method of this invention is a convenient dry process that readily allows one to deposit successive layers of catalyst in a high uniformity controllable manner.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A close proximity pulsed laser catalyst deposition system comprising:
a first medium containing layer of a catalyst to be deposited;
a second medium disposed across a gap from and facing said layer of catalyst to be deposited, said gap being at ambient atmospheric pressure; and
a pulsed laser for applying an energy beam pulse above the ablative energy threshold of said catalyst to create a vaporized plume of the catalyst and direct said vaporized plume across the gap at ambient atmospheric pressure to deposit a porous, finely divided coating of increased surface area of said catalyst on said second medium.

2. The close proximity pulsed laser deposition system of claim 1 in which said ambient atmospheric pressure includes atmospheric and near atmospheric pressure.

3. The close proximity pulsed laser deposition system of claim 1 in which said gap is less than approximately one centimeter.

4. The close proximity pulsed laser deposition system of claim 1 in which said gap is approximately one millimeter or less.

5. The close proximity pulsed laser deposition system of claim 1 in which said first medium is transparent at the wavelength of said pulsed laser.

6. The close proximity pulsed laser deposition system of claim 5 in which said pulsed laser is on the opposite side of said first layer from said layer of catalyst and said gap.

7. The close proximity pulsed laser deposition system of claim 1 in which said pulsed laser is an excimer laser.

8. The close proximity pulsed laser deposition system of claim 1 further including a drive mechanism for moving at least one of said mediums and said beam pulse relative to the others.

9. The close proximity pulsed laser deposition system of claim 1 in which said layer of catalyst is a metal.

10. The close proximity pulsed laser deposition system of claim 9 in which said catalyst is a noble metal.

11. The close proximity pulsed laser deposition system of claim 9 in which said catalyst is a metal chosen from the group consisting of copper, silver, gold, nickel, palladium, platinum, rhodium and iridium.

12. The close proximity pulsed laser deposition system of claim 1 in which said gap contains a gas.

13. The close proximity pulsed laser deposition system of claim 12 in which said gas includes air.

14. The close proximity pulsed laser deposition system of claim 12 in which said gas includes argon.

15. The close proximity pulsed laser deposition system of claim 1 in which said coating includes a finely divided weblike network of particles.

16. The close proximity pulsed laser deposition system of claim 15 in which said particles are approximately three nanometers in diameter or less.

17. The close proximity pulsed laser deposition system of claim 1 in which the fluence of said beam pulse is in the range of about 0.5 to 1.5 joules/cm².

18. The close proximity pulsed laser deposition system of claim 1 in which said beam pulse duration is about 0.5 seconds or less.

19. The close proximity pulsed laser deposition system of claim 1 in which said material on said first medium is up to 0.5 microns in thickness.

20. The close proximity pulsed laser deposition system of claim 1 in which said first medium is a polymer.

21. The close proximity pulsed laser deposition system of claim 1 in which said second medium includes carbon.

22. The close proximity pulsed laser deposition system of claim 1 in which said second medium includes perfluorosulfomate polymer.

23. The close proximity pulsed laser deposition system of claim 1 in which said coating is approximately 0.04 mg/cm².

24. A close proximity pulsed laser catalyst deposition system for a fuel cell comprising:
a first medium containing a layer of catalyst to be deposited;
an electrode disposed across a gap from and facing said layer of catalyst to be deposited, said gap being at ambient atmospheric pressure; and
a pulsed laser for applying an energy beam pulse above the ablative energy threshold of said catalyst to create a vaporized plume of the catalyst and direct said vaporized plume across the gap at ambient atmospheric pressure to deposit a porous, finely divided coating of increased surface area of said electrode on said second medium.

25. The close proximity pulsed laser catalyst deposition system of claim 24 in which said electrode is a cathode.

26. The close proximity pulsed laser catalyst deposition system of claim 24 in which said electrode is an anode.

27. The close proximity pulsed laser catalyst deposition system of claim 24 in which said electrode is disposed on one or both sides of a conductive polymer membrane of a fuel cell.

28. The close proximity pulsed laser catalyst deposition system of claim 27 in which said conductive polymer membrane is sandwiched between said electrode and said anode.

29. The close proximity pulsed laser catalyst deposition system of claim 24 in which said ambient atmospheric pressure includes atmospheric and near atmospheric pressure.

30. The close proximity pulsed laser catalyst deposition system of claim 24 in which said gap is less than approximately one centimeter.

31. The close proximity pulsed laser catalyst deposition system of claim 24 in which said gap is approximately one millimeter or less.

32. The close proximity pulsed laser catalyst deposition system of claim 24 in which said first medium is transparent at the wavelength of said pulsed laser.

33. The close proximity pulsed laser catalyst deposition system of claim 24 further including a drive mechanism for moving at least one of said mediums and said beam pulse relative to the others.

34. The close proximity pulsed laser catalyst deposition system of claim 24 in which said layer of catalyst is a metal chosen from the group consisting of copper, silver, gold, nickel, palladium, platinum, rhodium and iridium.

35. The close proximity pulsed laser catalyst deposition system of claim 24 in which said gap contains a gas.

36. The close proximity pulsed laser catalyst deposition system of claim 35 in which said gas includes air.

37. The close proximity pulsed laser catalyst deposition system of claim 24 in which said coating is approximately 0.04 mg/cm².

38. A close proximity pulsed laser catalyst deposition system for an electrolyzer comprising:
a first medium containing layer of catalyst to be deposited;
an electrode medium disposed across a gap from and facing said layer of catalyst to be deposited, said gap being at ambient atmospheric pressure; and
a pulsed laser for applying an energy beam pulse above the ablative energy threshold of said catalyst to create a vaporized plume of the catalyst and direct said vaporized plume across the gap at ambient atmospheric pressure to deposit a porous, finely divided coating of increased surface area of said electrode on said second medium.

39. The close proximity pulsed laser catalyst deposition system of claim 38 in which said electrode is a cathode.

40. The close proximity pulsed laser catalyst deposition system of claim 38 in which said electrode is an anode.

41. The close proximity pulsed laser catalyst deposition system of claim 38 in which said electrode is disposed on one or both sides of a conductive polymer membrane.

42. The close proximity pulsed laser catalyst deposition system of claim 38 in which said conductive polymer membrane is sandwiched between said electrode and said anode.

43. The close proximity pulsed laser catalyst deposition system of claim 38 in which said ambient atmospheric pressure includes atmospheric and near atmospheric pressure.

44. The close proximity pulsed laser catalyst deposition system of claim 38 in which said gap is less than approximately one centimeter.

45. The close proximity pulsed laser catalyst deposition system of claim 38 in which said gap is approximately one millimeter or less.

46. The close proximity pulsed laser catalyst deposition system of claim 38 in which said first medium is transparent at the wavelength of said pulsed laser.

47. The close proximity pulsed laser catalyst deposition system of claim 38 further including a drive mechanism for moving at least one of said mediums and said beam pulse relative to the others.

48. The close proximity pulsed laser catalyst deposition system of claim 38 in which said layer of catalyst is a metal chosen from the group consisting of copper, silver, gold, nickel, palladium, platinum, rhodium and iridium.

49. The close proximity pulsed laser catalyst deposition system of claim 38 in which said gap contains a gas.

50. The close proximity pulsed laser catalyst deposition system of claim 49 in which said gas includes air.

51. The close proximity pulsed laser catalyst deposition system of claim 38 in which said coating is approximately 0.04 mg/cm².

52. A close proximity pulsed laser method for depositing a catalyst on a medium, the method comprising:
providing a first medium containing a layer of catalyst to be deposited;
providing a second medium disposed across a gap from and facing said layer of catalyst to be deposited, said gap being at ambient atmospheric pressure; and
applying an energy beam pulse above the ablative energy threshold of said catalyst with said pulsed laser to create a vaporized plume of said catalyst and direct said vaporized plume across said gap at ambient atmospheric pressure to deposit a porous, finely divided coating of increased surface area of said catalyst on said second medium.

53. The method of claim 52 in which said ambient atmospheric pressure includes atmospheric and near atmospheric pressure.

54. The method of claim 52 in which said gap is less than approximately one centimeter.

55. The method of claim 52 in which said gap is approximately one millimeter or less.

56. The method of claim 52 in which said first medium is transparent at the wavelength of said pulsed laser.

57. The method of claim 52 in which said layer of catalyst is a metal chosen from the group consisting of copper, silver, gold, nickel, palladium, platinum, rhodium and iridium.

58. The method of claim 52 in which said gap contains a gas.

59. The close proximity pulsed laser deposition system of claim 58 in which said gas includes air.

60. The method of claim 52 in which said coating is approximately 0.04 mg/cm².

61. A close proximity pulsed laser cell method for depositing a catalyst on a medium of a fuel cell, the method comprising:
providing a first medium containing a layer of catalyst to be deposited;
providing an electrode disposed across a gap from and facing said layer of catalyst to be deposited, said gap being at ambient atmospheric pressure; and
applying an energy beam pulse above the ablative energy threshold of said catalyst with pulsed laser to create a vaporized plume of said catalyst and direct said vaporized plume across the gap at ambient atmospheric pressure to deposit a porous, finely divided coating of increased surface area of said catalyst on said electrode.

62. The method of claim 61 in which said ambient atmospheric pressure includes atmospheric and near atmospheric pressure.

63. The method of claim 61 in which said gap is less than approximately one centimeter.

64. The method of claim 61 in which said gap is approximately one millimeter or less.

65. The method of claim 61 in which said first medium is transparent at the wavelength of said pulsed laser.

66. The method of claim 61 in which said layer of catalyst is a metal chosen from the group consisting of copper, silver, gold, nickel, palladium, platinum, rhodium and iridium.

67. The method of claim 61 in which said gap contains a gas.

68. The method of claim 67 in which said gas includes air.

69. The method of claim 61 in which said coating is approximately 0.04 mg/cm².

70. A close proximity pulsed laser cell method for depositing a catalyst on a medium of an electrolyzer, the method comprising:
providing a first medium containing a layer of catalyst to be deposited;
providing an electrode disposed across a gap from and facing said layer of catalyst to be deposited, said gap being at ambient atmospheric pressure; and
applying an energy beam pulse above the ablative energy threshold of said catalyst with pulsed laser to create a vaporized plume of said catalyst and direct said vaporized plume across the gap at ambient atmospheric pressure to deposit a porous, finely divided coating of increased surface area of said catalyst on said electrode.

71. The method of claim 70 in which said ambient atmospheric pressure includes atmospheric and near atmospheric pressure.

72. The method of claim 70 in which said gap is less than approximately one centimeter.

73. The method of claim 70 in which said gap is approximately one millimeter or less.

74. The method of claim 70 in which said first medium is transparent at the wavelength of said pulsed laser.

75. The method of claim 70 in which said layer of catalyst is a metal chosen from the group consisting of copper, silver, gold, nickel, palladium, platinum, rhodium and iridium.

76. The method of claim 70 in which said gap contains a gas.

77. The method of claim 76 in which said gas includes air.

78. The method of claim 76 in which said coating is approximately 0.04 mg/cm².

79. A close proximity pulsed laser catalyst deposition system comprising:
a first medium containing layer of a catalysts to be deposited;
a second medium disposed across a gap from and facing said layer of catalysts to be deposited, said gap being at ambient atmospheric pressure; and
a pulsed laser for applying an energy beam pulse above the ablative energy threshold of said catalysts to create a vaporized plume of the catalysts and direct said vaporized plume across the gap at ambient atmospheric pressure to deposit a porous, finely divided coating of increased surface area of said catalysts on said second medium.

80. The close proximity pulsed laser deposition system of claim 1 in which said layer of catalysts includes two or more metals.

81. The close proximity pulsed laser deposition system of claim 80 in which said metals are platinum and rhodium.

82. The close proximity pulsed laser deposition system of claim 79 in which said catalysts are chosen from the group consisting of copper, silver, gold, nickel, palladium, rhodium and iridium.

83. The close proximity pulsed laser deposition system of claim 79 in which said coating is approximately 0.04 mg/cm².

84. A close proximity pulsed laser catalyst deposition system comprising:
a plurality of first mediums, each said first medium containing layer of a catalyst to be deposited;
a plurality of second mediums, each said second medium disposed across a gap from and facing said layer of catalyst to be deposited, said gap being at ambient atmospheric pressure; and
a plurality of pulsed lasers for applying an energy beam pulses above the ablative energy threshold of said catalyst of each said plurality first mediums to create vaporized plumes of the catalyst and direct said vaporized plumes across the gap at ambient atmospheric pressure to deposit a plurality of porous, finely divided coatings of increased surface area of said catalyst on each said plurality of second medium.

84. The close proximity pulsed laser catalyst deposition system of claim 83 in which coatings include carbon and platinum.

85. The close proximity pulsed laser catalyst deposition system of claim 83 in which coatings include carbon and platinum.

86. The close proximity pulsed laser catalyst deposition system of claim 83 in which said coating is approximately 0.04 mg/cm².

87. A close proximity pulsed laser catalyst deposition system comprising:
a first medium containing layer of a catalyst to be deposited;
a second medium disposed across a gap from and facing said layer of catalyst to be deposited, said gap being at ambient atmospheric pressure;
a pulsed laser for providing an energy beam pulse above the ablative energy threshold of said catalyst to a predetermined exposure area on said layer of catalyst to create a vaporized plume of the catalyst from that predetermined exposure area and direct said vaporized plume from that predetermined exposure area across the gap at ambient atmospheric pressure; and
a driver device for producing relative motion between said predetermined exposure area on said layer of catalyst and said second medium to selectively deposit a porous, finely divided coating of increased surface area of said catalyst on said second medium.

88. The close proximity pulsed laser catalyst deposition system of claim 87 in which said driver device includes a beam steering device for moving said beam to a series of predetermined exposure areas on said layer of catalyst.

89. The close proximity pulsed laser catalyst deposition system of claim 87 in which said driver device includes a drive mechanism for moving said first and second medium relative to each other.

90. The close proximity pulsed laser catalyst deposition system of claim 87 in which said coating is approximately 0.04 mg/cm².

91. A close proximity pulsed laser catalyst deposition system for a fuel cell comprising:
a first medium containing layer of a catalyst to be deposited;
an electrode disposed across a gap from and facing said layer of catalyst to be deposited, said gap being at ambient atmospheric pressure;
a pulsed laser for providing an energy beam pulse above the ablative energy threshold of said catalyst to a predetermined exposure area on said layer of catalyst to create a vaporized plume of the catalyst from that predetermined exposure area and direct said vaporized plume from that predetermined exposure area across the gap at ambient atmospheric pressure; and
a driver device for producing relative motion between said predetermined exposure area on said layer of catalyst and said second medium to selectively deposit a porous, finely divided coating of increased surface area of said catalyst on said electrode.

92. The close proximity pulsed laser catalyst deposition system for a fuel cell of claim 91 in which said driver device includes a beam steering device for moving said beam to a series of predetermined exposure areas on said layer of catalyst.

93. The close proximity pulsed laser catalyst deposition system for a fuel cell of claim 91 in which said driver device includes a drive mechanism for moving said first medium and said electrode relative to each other.

94. The close proximity pulsed laser catalyst deposition system for a fuel cell of claim 91 in which said coating is approximately 0.04 mg/cm².

95. The close proximity pulsed laser catalyst deposition system for a fuel cell of claim 91 in which said electrode is an anode.

96. The close proximity pulsed laser catalyst deposition system for a fuel cell of claim 91 in which said electrode is a cathode.
